(19) United States
(12) Patent Application Publication
(10) Pub. No.: US 2018/0140486 A1
(43) Pub. Date: May 24, 2018

(54) Wheelchair Electric Mobility Attachment and A Wheelchair having Integrated Electric Mobility Capability

(71) Applicant: Keren Klein, Herzeliya (IL)

(72) Inventor: Keren Klein, Herzeliya (IL)

(21) Appl. No.: 15/361,043

(22) Filed: Nov. 24, 2016

(51) Int. Cl. A61G 5/04; A61G 5/10; A61G 5/12; A61G 5/08

(52) U.S. Cl. CPC A61G 5/047; A61G 5/046; A61G 5/1024; A61G 5/1051; A61G 5/122; A61G 2203/10; A61G 5/124; A61G 5/128; A61G 5/0875; A61G 5/0833; A61G 5/125

(57) ABSTRACT

Disclosed is a Wheelchair Electric Mobility Attachment including a rear wheels chassis functionally connected to a front chassis fork, for positioning two or more rear wheels of the mobility attachment, as part of a wheelchair connection scheme, at a position behind (further back from) the axle of the rear wheels of the wheelchair to which said attachment is being connected.

### FIELD OF THE INVENTION

The present invention generally relates to the fields of Accessibility, Mobility Solutions for the Handicapped or Disabled, and Wheelchair Design; and more particularly, to a wheelchair electric mobility attachment and a wheelchair having integrated electric mobility capability.

### BACKGROUND

A motorized wheelchair, power chair, electric wheelchair or electric-powered wheelchair (EPW) is a wheelchair that is propelled by means of an electric motor rather than manual power. Motorized wheelchairs are useful for those unable to propel a manual wheelchair or who may need to use a wheelchair for distances or over terrain which would be fatiguing in a manual wheelchair. They may also be used not just by people with ‘traditional’ mobility impairments, but also by people with cardiovascular and fatigue-based conditions.

The existing motorized wheelchairs, and a wide range of existing solutions involving the inclusion of an electric mobility add-on or attachment by use of coupling mechanism, however, suffer from limited maneuverability and access capabilities, and from an installation process and fit which in many cases is too bulky and cumbersome for the user. In addition—electric wheelchair and/or manual wheelchairs using existing geometrical design suffer from inherent instability while sloping, climbing or turning thus requiring the user to be accompanied by a caregiver.

Accordingly, there remains a need, in the fields of: Accessibility, Mobility Solutions for the Handicapped or Disabled, and Wheelchair Design, for wheelchair mobility solutions facilitating revised geometrical structure of the wheelchair and/or of electric add-ons or attachments thereof. Such solutions may re-distribute the existing wheelchair's, and its user's, weight—thus allowing existing manual wheelchairs, or wheelchairs having similar integrated capabilities, to move forwards and backwards, climb steeper slopes without tilting over backwards, and allow the user greater maneuverability and easier access than existing wheelchairs, electric or not, without the need for a caregiver.

### SUMMARY OF THE INVENTION

According to some embodiments, there may be provided a wheelchair electric mobility attachment, and a wheelchair having integrated electric mobility capability, having a front wheel and two or more rear wheels, wherein upon connection of the attachment, the two or more rear wheels may be positioned at or behind (further back from) the axle of the rear wheels of a wheelchair to which the attachment is connected. Once connected, the weight of the attachment, the wheelchair, and optionally a user (subject/rider sitting in the wheelchair), may be divided between: the two or more rear wheels of the attachment, the rear wheels of the wheelchair (e.g. a wheelchair having two rear wheels and two front caster wheels), and the front wheel of the attachment—the weight supporting wheels collectively forming a substantially convex pentagon shaped form, when viewed from the top, wherein the back wheels of the attachment constitute a first vertex and a second vertex at each of the two edges of the base of the pentagon, the front wheel of the attachment constitutes the opposite vertex, and each of the rear wheels of the wheelchair constitutes one of the other two (side) vertexes of the convex pentagon shape.

According to some embodiments of the present invention, the wheelchair electric mobility attachment may comprise: a front wheel; two or more rear wheels; and a rear wheels chassis for connecting between the two or more rear wheels and a front chassis.

According to some embodiments, the rear wheels chassis may comprise: a first (e.g. right) chassis track; and at least a second (e.g. left) chassis track; wherein the first and second chassis tracks are connected to each other, substantially at their rear sections, through a chassis track connector. According to some embodiments, the front chassis may be functionally connected to: a front chassis fork for connecting between the front chassis and the rear wheels chassis; and a front wheel fork for connecting between the front chassis and the axle of the front wheel. The front chassis may comprise handlebars, or another front wheel directing mechanism, substantially at its upper section.

According to some embodiments, a lifting arm may be functionally connected to the front chassis, directly, or through a lifting arm connector. The front chassis fork may be connected, substantially at its top section, to a bottom section of a linear actuator, wherein the linear actuator is connected at its upper (opposite) section to the lifting arm. The lifting arm may include, on its opposite side from the lifting arm connector side: a wheelchair connector (e.g. a connection cross bar) for connecting it to the frame/seat of the wheelchair to which the attachment is being connected; and a rear chassis fork for supporting and/or connecting between the lifting arm and the rear wheels chassis.

According to some embodiments, as part of a connection scheme between the attachment and a wheelchair, the lifting arm, being pushed substantially upwards by the actuator, may lift the front section of the wheelchair, including its front caster wheels, from the ground, leaving the weight of the wheelchair to be distributed over the front wheel of the attachment and the back wheels of the wheelchair to which the attachment is connected. Footplates of the wheelchair, used for supporting the feet of its user (rider) while seated with it, and possibly additional components which are part of the front section of the wheelchair, may also be elevated as part of the lifting process.

Lifting the front section of the wheelchair (e.g. front caster wheels and footplates) may allow for the rear wheels chassis to travel, along with the rear wheels and while its trajectory is being guided by the first chassis track and the second chassis track moving along the front chassis fork and rear chassis fork, in the direction of the back of the wheelchair to which the attachment is connected, and to a position wherein the rear wheels are at or behind (further back from) the axle of the rear wheels of a wheelchair to which the attachment is connected, redistributing the weight of the wheelchair over: the front wheel of the attachment, the back wheels of the wheelchair to which the attachment is connected and the rear wheels of the attachment.

According to some embodiments, the wheelchair attachment may include one or more power sources such as, but not limited to, rechargeable batteries. The rechargeable batteries may include: a front battery, that may be connected to the front chassis (e.g. a battery housing for detachably connecting and retaining the battery, on the front of the front chassis) for supplying, through a wire(s), electric power to a front wheel motor for spinning the front wheel of the attachment; and/or a rear battery, connected to one or both of the chassis tracks of the rear wheels chassis, substantially at their rear sections, and/or connected to the chassis track connector (e.g. on its back side), for supplying, through a wire(s), electric power to one or more rear wheels motors for spinning one or more of the rear wheels of the attachment.

A fully built, complete (not an attachment) wheelchair, in accordance with some embodiments of the present invention, may include 5 wheels: 2 in the rear, 1 in the front and 2 in the middle. The front and rear wheels and optionally the side wheels, may include respective electric motors, wherein the 5 weight supporting wheels collectively form a substantially convex pentagon shaped form, when viewed from the top, wherein the back wheels of the attachment constitute a first vertex and a second vertex at each of the two edges of the base of the pentagon, the front wheel of the attachment constitutes the opposite vertex, and each of the rear wheels of the wheelchair constitutes one of the other two (side) vertexes of the convex pentagon shape. The complete wheelchair may have substantially similar proportions as the electric mobility attachment when connected to a standard wheelchair. According to some embodiments, the complete wheelchair may include sideway swiveling chair, possibly instead of the lifting arm, for allowing for easy entry and exit of the wheelchair user/rider in and out of the seat.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings:

FIG. 1A shows a perspective view of an exemplary wheelchair electric mobility attachment in an initial pre-connection position (wheelchair not shown), in accordance with some embodiments of the present invention;

FIG. 1B shows a perspective view of an exemplary wheelchair electric mobility attachment in a final post-connection position (wheelchair not shown), in accordance with some embodiments of the present invention;

FIG. 1C shows a side view of an exemplary wheelchair electric mobility attachment in a final post-connection position (wheelchair not shown), in accordance with some embodiments of the present invention;

FIG. 1D shows a front view of an exemplary wheelchair electric mobility attachment in a final post-connection position (wheelchair not shown), in accordance with some embodiments of the present invention;

FIG. 2A shows a side view of an exemplary wheelchair electric mobility attachment and a wheelchair, in accordance with some embodiments of the present invention, in a first, initial position of a connection scheme;

FIG. 2B shows a side view of an exemplary wheelchair electric mobility attachment and a wheelchair, in accordance with some embodiments of the present invention, in a second position of a connection scheme;

FIG. 2C shows a side view of an exemplary wheelchair electric mobility attachment and a wheelchair, in accordance with some embodiments of the present invention, in a third position of a connection scheme;

FIG. 2D shows a side view of an exemplary wheelchair electric mobility attachment and a wheelchair, in accordance with some embodiments of the present invention, in a fourth, final position of a connection scheme;

FIG. 2E shows a top view of an exemplary wheelchair electric mobility attachment and a wheelchair, in accordance with some embodiments of the present invention, in a fourth, final position of a connection scheme;

FIG. 2F is a flowchart showing the main steps executed as part of an exemplary connection scheme between a wheelchair electric mobility attachment and a wheelchair, in accordance with some embodiments of the present invention;

FIG. 2G shows a perspective view of an exemplary wheelchair electric mobility attachment and a wheelchair, in accordance with some embodiments of the present invention, in a fourth, final position of a connection scheme;

FIG. 3 shows, in further detail, an exemplary linear actuator, an exemplary lifting arm, and an exemplary lifting arm connector, in accordance with some embodiments of the present invention;

FIG. 4 shows, in further detail, an exemplary wheelchair connector (connection cross bar), and an exemplary rear chassis fork, in accordance with some embodiments of the present invention;

FIG. 5 shows, in further detail, an exemplary rear wheel chassis track to front chassis fork connection, in accordance with some embodiments of the present invention;

FIG. 6 shows, in further detail, an exemplary rear wheel chassis track connected, utilizing an exemplary shock absorber, to an exemplary rear wheel, in accordance with some embodiments of the present invention;

FIG. 7 shows a side view of an exemplary wheelchair including an integrated electric mobility capability, in accordance with some embodiments of the present invention; and

FIG. 8 shows, in further detail, an exemplary control and output unit, in accordance with some embodiments of the present invention.

It will be appreciated that for simplicity and clarity of illustration, elements shown in the figures have not necessarily been drawn to scale. For example, the dimensions of some of the elements may be exaggerated relative to other elements for clarity.

### DETAILED DESCRIPTION

In the following detailed description, numerous specific details are set forth in order to provide a thorough understanding of some embodiments. However, it will be understood by persons of ordinary skill in the art that some embodiments may be practiced without these specific details. In other instances, well-known methods, procedures, components, units and/or circuits have not been described in detail so as not to obscure the discussion.

Embodiments of the present invention may include apparatuses for performing the operations herein. Such apparatus may be specially constructed for the desired purposes, or it may comprise of general-purpose components. The processes and components presented herein are not inherently related to any particular embodiment, various general-purpose devices, methods, systems and/or apparatuses may be used in accordance with the teachings herein, or it may prove convenient to construct more specialized devices, methods, systems and/or apparatuses to perform/produce the desired action. The desired structure for a variety of these devices, methods, systems and/or apparatuses will appear from the description below.

Functions, operations, components and/or features described herein with reference to one or more embodiments, may be combined with, or may be utilized in combination with, one or more other functions, operations, components and/or features described herein with reference to one or more other embodiments, or vice versa.

Unless specifically stated otherwise, as apparent from the following discussions, it is appreciated that throughout the specification discussions utilizing terms such as ‘attachment’, ‘add-on’, ‘apparatus’, or the like, refer to a device/unit/system that is detachably connectable to a wheelchair, and improves or affects the mobility thereof. Further, the term ‘wheelchair’ may relate to any type, electric or manual, of a human mobilizing system, such as, but not limited to, those utilized for providing mobility and accessibility to handicapped, disabled, injured, or elsewise physically limited subjects.

In some or all of the following descriptions, a specific exemplary wheelchair configuration has been used to describe the embodiments of the invention and the features and operation thereof. It is hereby made clear, that these descriptions may be likewise applicable to various additional/other wheelchair types and configurations, and/or to any type, electric or manual, of a human mobilizing system, method, device, and/or apparatus.

The present invention includes a Wheelchair Electric Mobility Attachment having a front wheel and two or more rear wheels, wherein upon connection of the attachment, the two or more rear wheels may be positioned at or behind (further back from) the axle of the rear wheels of a wheelchair to which the attachment is connected. Once connected, the weight of the attachment, the wheelchair, and optionally a user (subject/rider sitting in the wheelchair), may be divided between: the two or more rear wheels of the attachment, the rear wheels of the wheelchair (e.g. a wheelchair having two rear wheels and two front caster wheels), and the front wheel of the attachment—the weight supporting wheels collectively forming a substantially convex pentagon shaped form, when viewed from the top, wherein the back wheels of the attachment constitute a first vertex and a second vertex at each of the two edges of the base of the pentagon, the front wheel of the attachment constitutes the opposite vertex, and each of the rear wheels of the wheelchair constitutes one of the other two (side) vertexes of the convex pentagon shape.

According to some embodiments of the present invention, the wheelchair electric mobility attachment may comprise: a front wheel; two or more rear wheels; and a rear wheels chassis for connecting between the two or more rear wheels and a front chassis.

According to some embodiments, the rear wheels chassis may comprise: a first (e.g. right) chassis track; and at least a second (e.g. left) chassis track; wherein the first and second chassis tracks are connected to each other, substantially at their rear sections, through a chassis track connector. According to some embodiments, the front chassis may be functionally connected to: a front chassis fork for connecting between the front chassis and the rear wheels chassis; and a front wheel fork for connecting between the front chassis and the axle of the front wheel. The front chassis may comprise handlebars, or another front wheel directing mechanism, substantially at its upper section.

According to some embodiments, a lifting arm may be functionally connected to the front chassis, directly, or through a lifting arm connector. The front chassis fork may be connected, substantially at its top section, to a bottom section of a linear actuator, wherein the linear actuator is connected at its upper (opposite) section to the lifting arm. The lifting arm may include, on its opposite side from the lifting arm connector side: a wheelchair connector (e.g. a connection cross bar—adjustable crossbar underneath wheelchair sit using “click-on” attachment to side bars of the wheel chair) for connecting it to the frame/seat of the wheelchair to which the attachment is being connected; and a rear chassis fork for supporting and/or connecting between the lifting arm and the rear wheels chassis.

According to some embodiments, as part of a connection scheme between the attachment and a wheelchair, the lifting arm, being pushed substantially upwards by the actuator, may lift the front section of the wheelchair, including its front caster wheels, from the ground, leaving the weight of the wheelchair to be distributed over the front wheel of the attachment and the back wheels of the wheelchair to which the attachment is connected. Footplates of the wheelchair, used for supporting the feet of its user (rider) while seated with it, and possibly additional components which are part of the front section of the wheelchair, may also be elevated as part of the lifting process.

Lifting the front section of the wheelchair (e.g. front caster wheels and footplates) may allow for the rear wheels chassis to travel, along with the rear wheels and while its trajectory is being guided by the first chassis track and the second chassis track moving along the front chassis fork and rear chassis fork, in the direction of the back of the wheelchair to which the attachment is connected, and to a position wherein the rear wheels are at or behind (further back from) the axle of the rear wheels of a wheelchair to which the attachment is connected, redistributing the weight of the wheelchair over: the front wheel of the attachment, the back wheels of the wheelchair to which the attachment is connected and the rear wheels of the attachment.

According to some embodiments, the present invention may consist of a fully built and complete electric mobility wheelchair (not as an attachable unit). A fully built electric mobility wheelchair may thus create a convex pentagon shaped wheelchair, when viewed from the top, wherein, the back wheels of the attachment constitute a first vertex and a second vertex at each of the two edges of the base of the pentagon, the front wheel of the attachment constitutes the opposite vertex, and each of the rear wheels of the wheelchair constitutes one of the other two (side) vertexes of the convex pentagon shape. According to some embodiments, the fully built wheelchair itself may have a side swivel ability (electric and/or mechanic) that may allow for a swiveling seat of the wheelchair for easy entering and exiting of the seat. The fully built wheelchair may include two additional electric or manual wheels that may vary in sizes (e.g. 5″-25″).

According to some embodiments, the wheelchair attachment may include one or more power sources such as, but not limited to, rechargeable batteries. The rechargeable batteries may include: a front battery, that may be connected to the front chassis (e.g. a battery housing for detachably connecting and retaining the battery, on the front of the front chassis) for supplying, through a wire(s), electric power to a front wheel motor for spinning the front wheel of the attachment; and/or a rear battery, connected to one or both of the chassis tracks of the rear wheels chassis, substantially at their rear sections, and/or connected to the chassis track connector (e.g. on its back side), for supplying , through a wire(s), electric power to one or more rear wheels motors for spinning one or more of the rear wheels of the attachment.

According to some exemplary embodiments of the present invention, the wheels of the attachment may vary in size (e.g. 4″-16″), and may comprise, or have integrated, hub motor brushless electric engines (e.g. two in the rear for each of two wheels and one in the front), wherein each motor/engine may consume, depending on the embodiment, anywhere between 250-2,500 Watts. According to some exemplary embodiments of the present invention, 24-48 Volts Lithium powered batteries with 6-36 Ampere capacity, which may for example allow the power needed for the wheelchair and the connected/integrated add-on/attachment to reach substantially high speed (e.g. 30 Km/h) and travel to a substantially long range (e.g. 10 Km).

According to some embodiments, each of the rear wheels may be functionally connected to a rear wheel suspension. Each of the rear wheel suspensions may comprise: a wheel connection element encompassing the wheel and including: (i) a first arm element for connection to the axle of the wheel, (ii) a second arm element for connection to substantially the rear section of a respective track of the rear wheels chassis, wherein the connection is a joint/hinge type connection allowing the wheel connection element along with its encompassed wheel to move (e.g. substantially/partially in an up and down direction) around the connection point of the joint/hinge of the track, and/or (iii) a third arm, positioned substantially at the top of the wheel connection element, for connection, by a joint/hinge type connection, to a first side of a shock absorber (e.g. coil/spring), wherein the second side of the shock absorber is connected, by a joint/hinge type connection, to substantially the top and rear section of the respective track of the rear wheels chassis. The shock absorber (e.g. coil/spring) may bias the third arm to be pushed backwards, causing the entire wheel connection element to be pushed around the second arm connection point, thus pushing the wheel substantially downward and keeping it in contact with the ground while absorbing shocks, as the wheels pass over non-flat ground sections such as bumps/dimples.

According to some embodiments, a control and output unit may be connected to the handlebars, allowing the user (rider) to: (i) relay commands to, or to controllers (e.g. control circuitries, motor controllers) of: the motors, actuator, brakes, lights, alert sound generation device, and/or other electric components of the attachment—such commands may include, but are not limited to: motor operation commands (e.g. speedup, slowdown), actuator operation commands (e.g. lift wheelchair up, lower wheelchair down), wheelchair attachment braking commands, lights related commands (e.g. light on/off, light blinking signal), and/or alert sound triggering commands; and/or (ii) present to the user (rider), acoustically and/or visually, information received from one or more controllers (e.g. control circuitries, motor controllers)—such information may include, but is not limited to: motor operation data (e.g. speed, temperature, load), battery operation data (e.g. remaining power, power drain rate, temperature), and/or wheel operation data (e.g. wheel spinning rate).

According to some embodiments, the separate sources of rear and front electric power supply to the motors, may enable propelling the wheelchair forwards or backwards while operating the motors individually or in concert. The motor controllers (e. g. control circuitries, electric controllers) may automatically distribute power from the different power sources to the different motors as needed to maximize traction, for example, when climbing steep slopes or side curbs.

According to some embodiments, the input (control) interface of the control unit may for example include: a finger throttle and buttons to move forwards and backwards in varying speeds & to break. According to some embodiments, the output interface of the control unit may for example include: a display and speakers to provide information and alerts to the user. According to some embodiments, further mechanical control units and/or output units, such as braking handles and/or a speedometer, may be connected to the handlebars.

According to some embodiments, the control and output unit may send and receive data via wireless communication. For example, the unit may include a Bluetooth wireless communication ‘master’ component, and each interfaced element (e.g. motor, actuator) of the attachment may include a Bluetooth wireless communication ‘slave’ component, for receiving communicated commands and relaying them to the respective element controller, and/or for communicating information received from the controllers of the elements in reply to an inquiry made by the control unit ‘master’ component. According to some embodiments, other wireless communication methods and protocols (e.g. Wi-Fi) may be utilized for facilitating control unit to attachment elements communication. According to some embodiments, over-wire (e.g. Ethernet, coax, optic fiber) communication methods and protocols may be utilized for facilitating control unit to attachment elements communication.

An exemplary wheelchair attachment connection scheme, of a wheelchair attachment in accordance with some embodiments of the present invention, from an initial position wherein the attachment is positioned substantially in front of a wheelchair and a user (e.g. rider) of the wheelchair is sitting in it, may include the following steps:

[1] The attachment, positioned in front of the wheelchair—in its initial position wherein the front chassis fork and rear chassis fork are furthest back along the tracks of the rear wheels chassis and the front section of the tracks of the rear wheels chassis sticks forward and up from the front of the front wheel fork, and wherein the front wheel and rear wheels of attachment are in contact with the ground—is either manually (i.e. by user sitting in wheelchair) rolled and brought close to the wheelchair, or the wheelchair is manually (i.e. by user sitting in wheelchair) rolled towards and close to the attachment.

[2] The wheelchair connector (e.g. connection cross bar) is used to connect the lifting arm, and thus the entire attachment, to the frame of the wheelchair at, or in proximity to, the seat (e. g. front of seat) of the wheelchair—such that upon completion each of the lower limbs of the user are on an opposite side of the lifting arm.

[3] In response to the user engaging a corresponding interface element of the control unit of the attachment—the linear actuator extends while pushing the lifting arm substantially in an upwards direction, thus lifting the front section of the wheelchair, including its front caster wheels, from the ground.

In response to the user engaging a corresponding interface element of the control unit of the attachment—the rear wheels motor(s) spin the rear wheels over the ground, a preset distance in reverse (i.e. back) direction, thus pulling and causing the rear wheels chassis tracks to travel, over the front chassis fork and the rear chassis fork, in the direction of the back of the wheelchair to which the attachment is connected, and to a position wherein the rear wheels are at or behind (further back from) the axle of the rear wheels of the wheelchair to which the attachment is connected. Upon the rear wheels chassis tracks reaching their final ‘stretched back’ position, connection shafts/rods on the front chassis fork, and possibly on the rear chassis fork, may snap into respective connection holes/dents on the tracks, thus retaining the rear wheels chassis in its position relative to the front chassis.

The attachment and the wheelchair connected thereto, in response to the user engaging a corresponding interface element of the control unit of the attachment, may trigger the operation of the front wheel motor and/or the rear wheels motor(s), and may spin (forward or backward) some or all of the wheels of the attachment over the ground, causing the attachment, and the wheelchair connected thereto, to be propelled/moved/transported (forward or backward).

The attachment and the wheelchair connected thereto, in response to the user engaging a corresponding interface element of the control unit of the attachment, may control the turning of the wheelchair sideways (stirring) by turning the axle of the front wheel, or by differentiating electric power to the back wheels, by using electrical (e.g. —“joystick”) and/or manual operation.

The attachment and the wheelchair connected thereto, in response to the user engaging a corresponding interface element of the control unit of the attachment, may control the stopping of the wheelchair (breaking) by electric powered breaks, disk brakes, and/or any breaking system to the front and/or back wheels, by using electrical (e.g. —“joystick”) and/or manual operation. Electric breaking system may use “regain” motor capabilities.

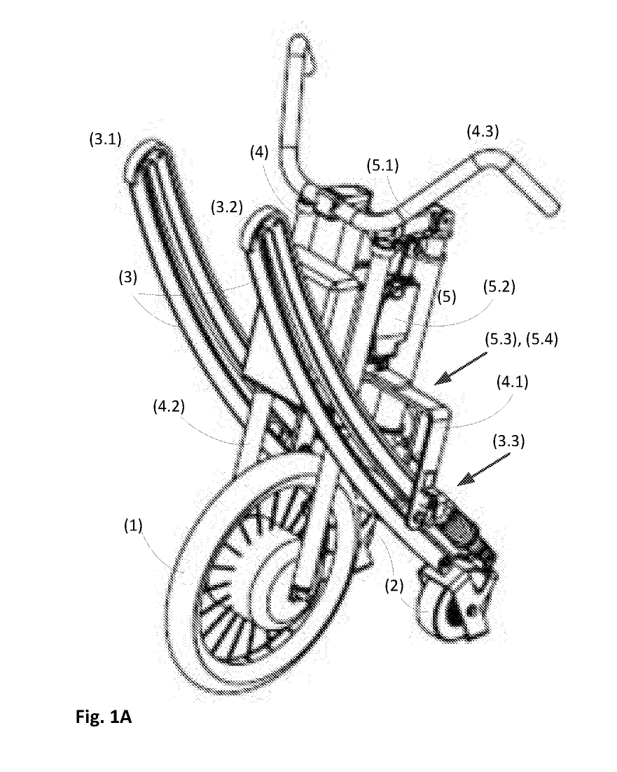

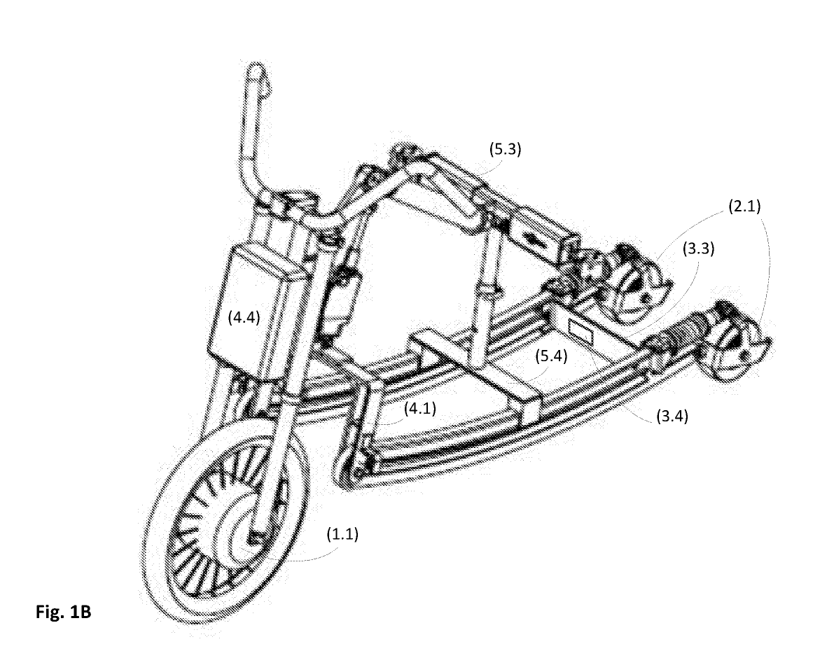

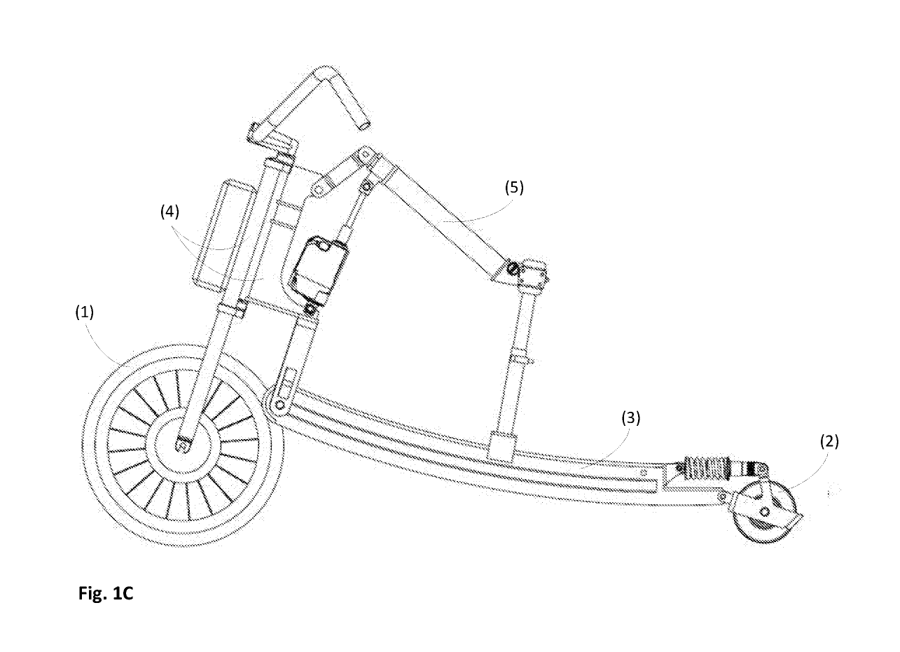

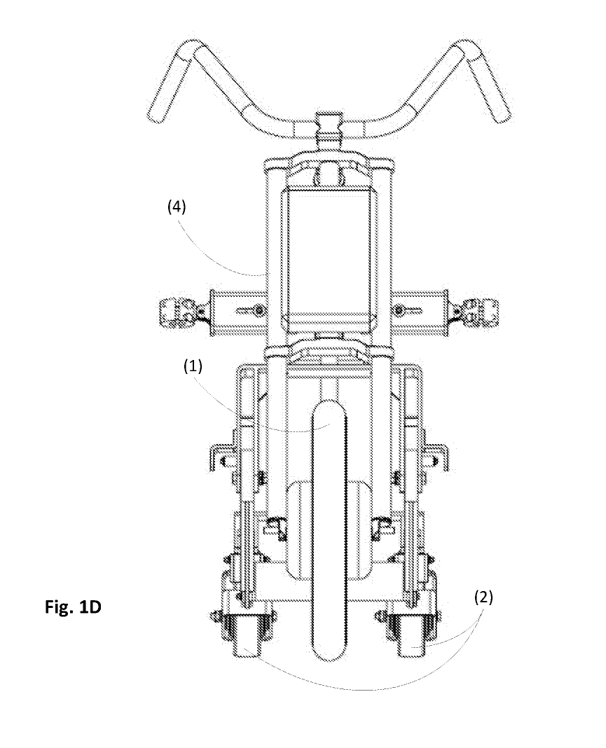

In FIG. 1A there is shown a perspective view of an exemplary wheelchair electric mobility attachment in an initial pre-connection position (wheelchair not shown), in accordance with some embodiments of the present invention. In the figure there are shown: (1) the front wheel of the attachment; (2) two rear wheels of the attachment; (3) the rear wheels chassis of the attachment; and (4) the front chassis of the attachment.

As part of the rear wheels chassis there are shown: (3.1) the first (right) and (3.2) the second (left) chassis tracks; and (3.3) the chassis track connector, connecting the first and second chassis tracks. Further shown are: (4.1) the front chassis fork for connecting between the front chassis and the rear wheels chassis; and (4.2) the front wheel fork for connecting between the front chassis and the axle of the front wheel. The shown front chassis comprises (4.3) handlebars at its upper section.

The (5) lifting arm shown, is connected to the front chassis through (5.1) the lifting arm connector, and the (4.1) front chassis fork is connected to the bottom section of (5.2) the linear actuator. The linear actuator is connected at its upper section to the (5) lifting arm. The shown lifting arm includes, on the opposite side from the (5.1) lifting arm connector, (5.3) a wheelchair connector of a connection cross bar type, for connecting it to the frame/seat of the wheelchair to which the attachment is connected, and (5.4) the rear chassis fork for connecting between the (5) lifting arm and the rear wheels chassis.

In the figure, the attachment is shown in an initial (storage/folded/pre-connection) position, wherein the attachment rests on its front wheel and two rear wheels, and wherein the (4.1) front chassis fork and (5.4) rear chassis fork are furthest back along the tracks of the rear wheels chassis and the front section of the tracks sticks forward and up from the front of the (4.2) front wheel fork of the attachment.

In FIG. 1B there is shown a perspective view of an exemplary wheelchair electric mobility attachment in a final post-connection position (wheelchair not shown), in accordance with some embodiments of the present invention.

In the figure, the attachment is shown in a final post-connection position, wherein the attachment rests on its front wheel and two rear wheels, and wherein the (4.1) front chassis fork and (5.4) rear chassis fork are furthest to the front along the tracks of the rear wheels chassis. The rear section of the tracks, and the rear wheels connected thereto, is extended backwards and down, to a position behind the axle of the rear wheels of a wheelchair connected to the attachment. Further shown in the figure are the (4.4) front battery and (3.4) rear battery for providing electric power to the (1.1) front wheel motor and to the (2.1) rear wheels motors, respectively.

In FIG. 1C there is shown a side view of an exemplary wheelchair electric mobility attachment in a final post-connection position (wheelchair not shown), in accordance with some embodiments of the present invention. The rear section of the tracks, and the rear wheels connected thereto, is extended backwards and down, to a position behind the axle of the rear wheels of a wheelchair connected to the attachment.

In FIG. 1D there is shown a front view of an exemplary wheelchair electric mobility attachment in a final post-connection position (wheelchair not shown), in accordance with some embodiments of the present invention. The rear section of the tracks, and the rear wheels connected thereto, is extended backwards and down, to a position behind the axle of the rear wheels of a wheelchair connected to the attachment.

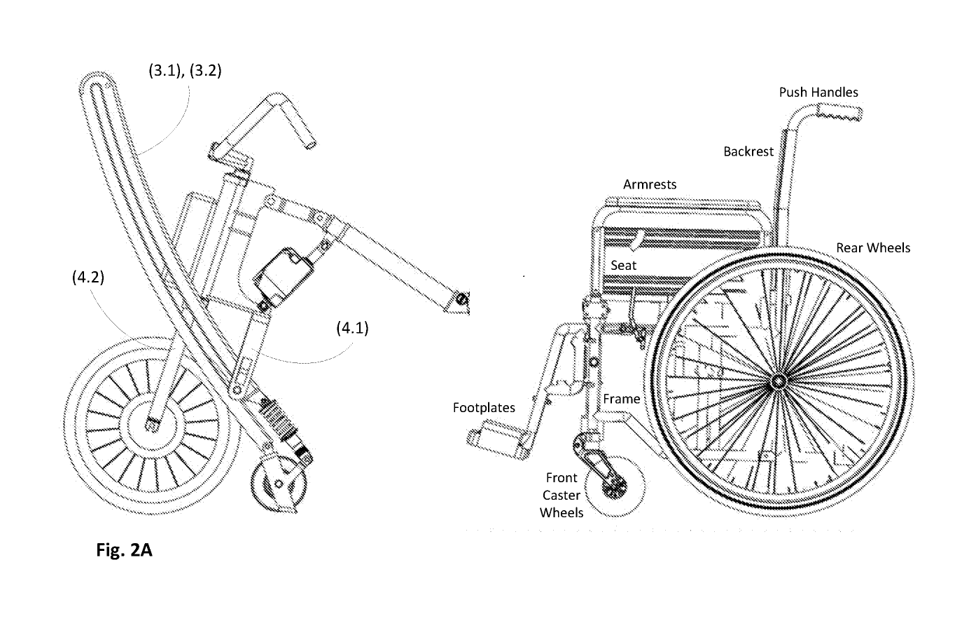

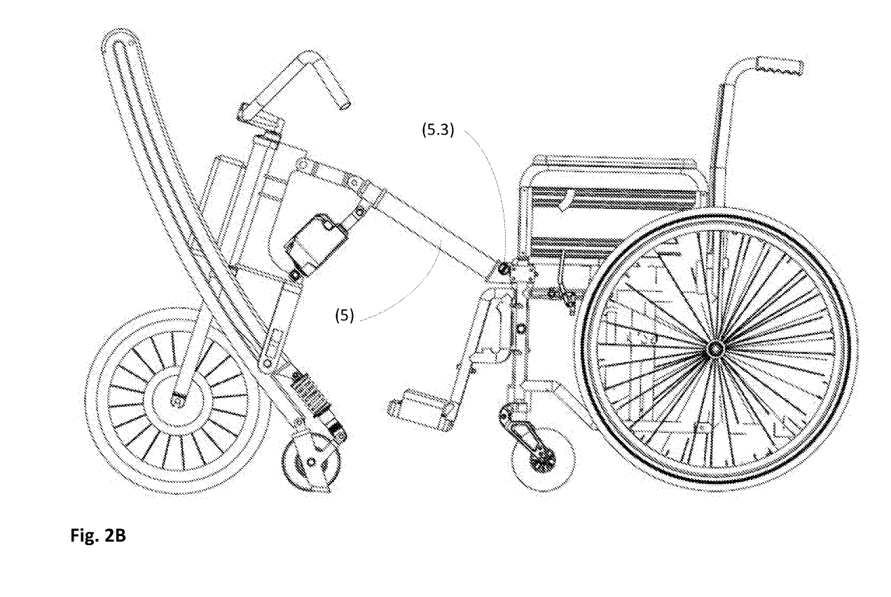

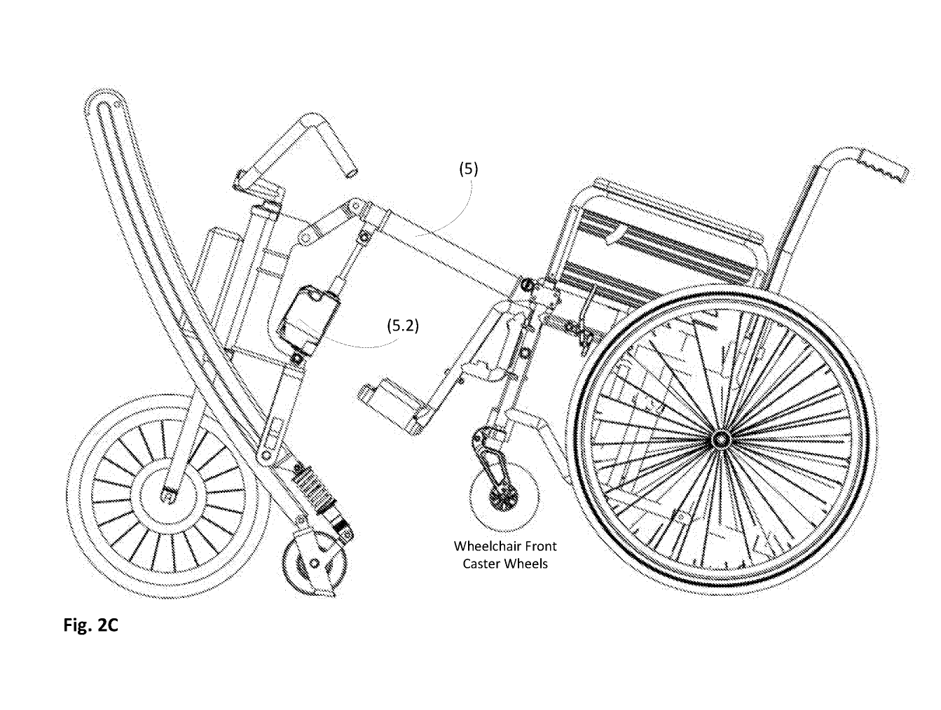

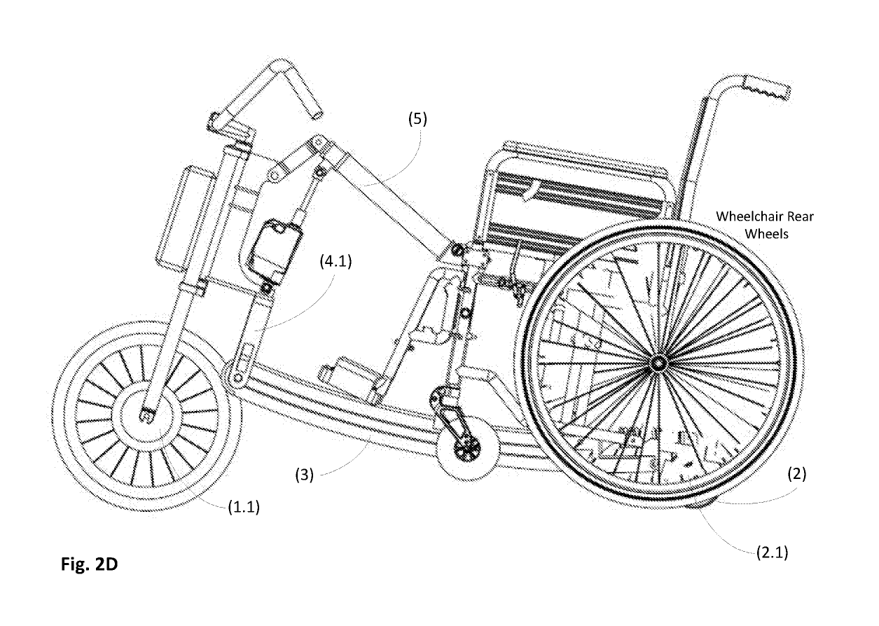

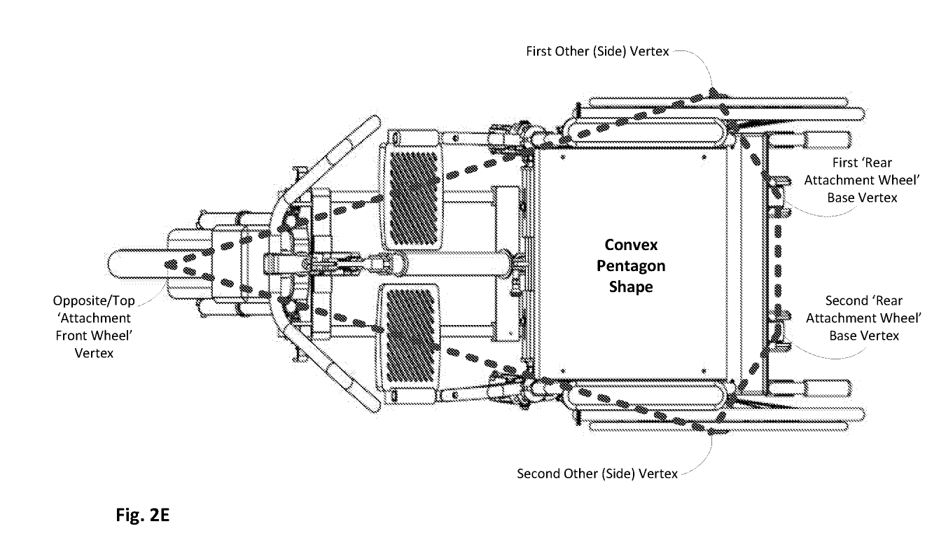

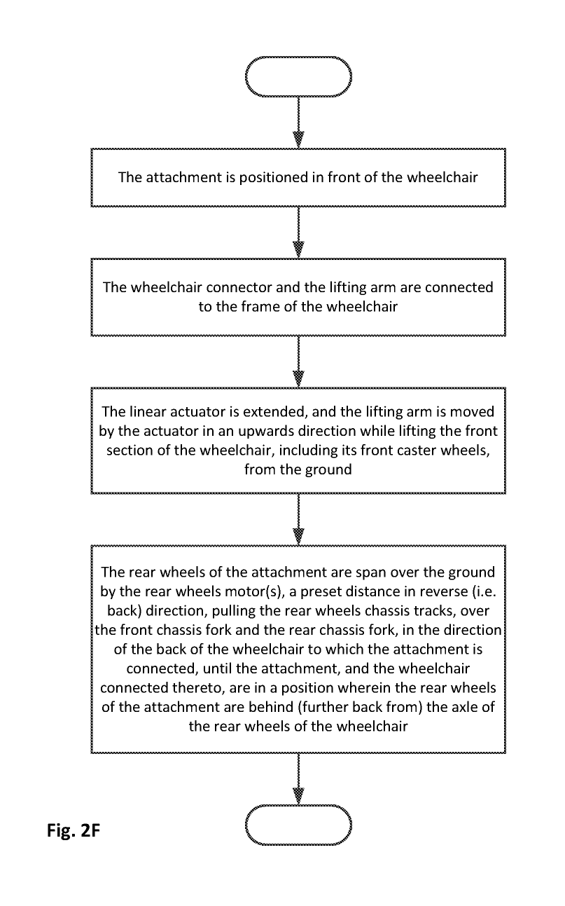

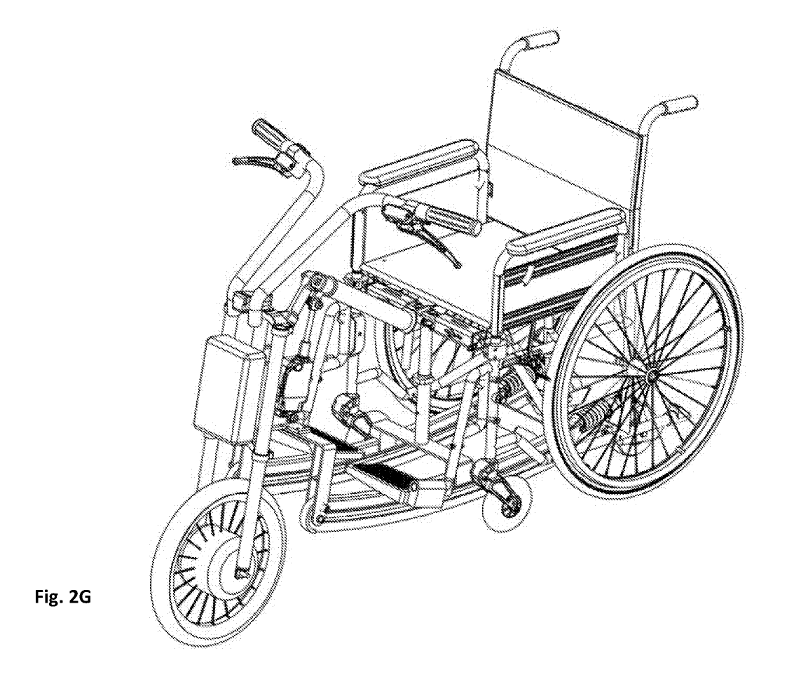

In FIG. 2A there is shown a side view of an exemplary wheelchair electric mobility attachment and a wheelchair, in accordance with some embodiments of the present invention, in a first, initial position of a connection scheme. In the figure, the attachment is shown positioned in front of the wheelchair. The (4.1) front chassis fork and (5.4) rear chassis fork are furthest back along the tracks of the rear wheels chassis and the front section of the tracks of the rear wheels chassis sticks forward and up from the front of the (4.2) front wheel fork. The front wheel and rear wheels of the attachment are in contact with the ground. From this position, the attachment is either manually (i.e. by user sitting in wheelchair) rolled and brought towards and closer to the wheelchair, or the wheelchair is manually (i.e. by user sitting in wheelchair) rolled towards and closer to the attachment.

The exemplary wheelchair selected and utilized in the figure, and in the following figures, to exemplify and demonstrate the functionalities of the wheelchair attachment, includes: (A) Push Handles; (B) a Backrest; (C) Armrests; (D) a Seat; (E) Footplates; and (F) a Frame, connecting the, and between, mentioned components, and wherein the frame is further functionally connected to: (G) two Rear Wheels, and (H) two Front Caster Wheels. Some or all of the functionalities of a wheelchair attachment in accordance with the present invention, may apply to a wide range of additional, wheelchair or mobility, solution types and/or configurations.

In FIG. 2B there is shown a side view of an exemplary wheelchair electric mobility attachment and a wheelchair, in accordance with some embodiments of the present invention, in a second position of a connection scheme. In the figure, the attachment is shown in a position wherein the (5.3) wheelchair connector of a connection cross bar type, was used to connect the (5) lifting arm, and thus the entire attachment, to the frame of the wheelchair in proximity to the front section of the seat.

In FIG. 2C there is shown a side view of an exemplary wheelchair electric mobility attachment and a wheelchair, in accordance with some embodiments of the present invention, in a third position of a connection scheme. In the figure, the attachment is shown in a position wherein—in response to the user engaging a corresponding interface element of the control unit of the attachment—the (5.2) linear actuator is extended, and the (5) lifting arm moved by the actuator in an upwards direction while lifting the front section of the wheelchair, including its front caster wheels, from the ground. The weight of the wheelchair and the connected attachment (and possibly the user/rider sitting in the wheelchair—not shown) now rest on the rear wheels of the wheelchair, the front wheel of the attachment, and the rear wheels of the attachment in their forward position in-front/ahead of the axle of the rear wheels of the wheelchair.

In FIG. 2D there is shown a side view of an exemplary wheelchair electric mobility attachment and a wheelchair, in accordance with some embodiments of the present invention, in a fourth, final position of a connection scheme. In the figure, the attachment is shown in a position wherein—in response to the user engaging a corresponding interface element of the control unit of the attachment—the (2.1) rear wheels motor(s) span the rear wheels over the ground, a preset distance in reverse (i.e. back) direction, thus pulling and causing the rear wheels chassis tracks to travel, over the (4.1) front chassis fork and the (5.4) rear chassis fork, in the direction of the back of the wheelchair to which the attachment is connected. The attachment, and the wheelchair connected thereto, are in a position wherein the rear wheels of the attachment are behind (further back from) the axle of the rear wheels of the wheelchair. The rear wheels chassis tracks are at their final ‘stretched back’ position, connection shafts/rods on the (4.1) front chassis fork are in respective connection holes/dents on the tracks, thus retaining the rear wheels chassis in its position relative to the front chassis.

In this final connection position, the attachment and the wheelchair connected thereto, in response to the user engaging a corresponding interface element of the control unit of the attachment, triggers the operation of the (1.1) front wheel motor and/or the (2.1) rear wheels motor(s), and spins (forward or backward) the corresponding wheels of the attachment over the ground, causing the attachment, and the wheelchair connected thereto, to be propelled/moved/transported (forward or backward).

In FIG. 2E there is shown a top view of an exemplary wheelchair electric mobility attachment and a wheelchair, in accordance with some embodiments of the present invention, in a fourth, final position (position side view is shown in FIG. 2D) of a connection scheme. In the figure, the attachment is shown in its final connection position, wherein, from a top view, the weight supporting wheels, of the attachment and the wheelchair, that are in contact with the ground, collectively form a convex pentagon shape—marked in the figure in broken lines. The back wheels of the attachment constitute a first vertex and a second vertex at each of the two edges of the base of the pentagon, the front wheel of the attachment constitutes the opposite (top) vertex, and each of the rear wheels of the wheelchair constitutes one of the other two (side) vertexes of the convex pentagon shape.

In FIG. 2F there is shown a flowchart of the main steps executed as part of an exemplary connection scheme between a wheelchair electric mobility attachment and a wheelchair, in accordance with some embodiments of the present invention. Shown steps include: [1] the attachment is positioned in front of the wheelchair; [2] the wheelchair connector and the lifting arm are connected to the frame of the wheelchair; [3] the linear actuator is extended, and the lifting arm is moved by the actuator in an upwards direction while lifting the front section of the wheelchair, including its front caster wheels, from the ground; and [4] the rear wheels of the attachment are span over the ground by the rear wheels motor(s), a preset distance in reverse (i.e. back) direction, pulling the rear wheels chassis tracks, over the front chassis fork and the rear chassis fork, in the direction of the back of the wheelchair to which the attachment is connected, until the attachment, and the wheelchair connected thereto, are in a position wherein the rear wheels of the attachment are behind (further back from) the axle of the rear wheels of the wheelchair.

In FIG. 2G there is shown a perspective view of an exemplary wheelchair electric mobility attachment and a wheelchair, in accordance with some embodiments of the present invention, in a fourth, final position of a connection scheme.

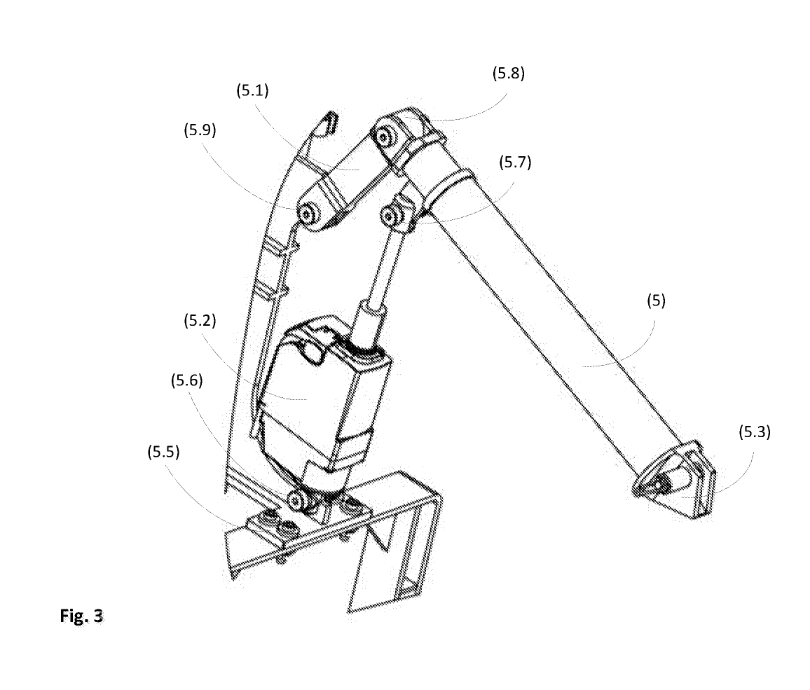

In FIG. 3 there are shown, in further detail, an exemplary (5.2) linear actuator, an exemplary (5) lifting arm, and an exemplary (5.1) lifting arm connector, in accordance with some embodiments of the present invention. In the figure, the following exemplary connections are shown: (5.5) a front chassis to front chassis fork connection; (5.6) a front chassis fork to linear actuator axis connection; (5.7) a linear actuator to lifting arm connector axis connection; (5.8) a lifting arm to lifting arm connector axis connection; (5.9) a lifting arm connector to front chassis axis connection; and (5.3) a wheelchair connector (not connected) for lifting arm to wheelchair, or to connection cross bar, connection. In the figure, the (5.2) linear actuator is shown in its extended position.

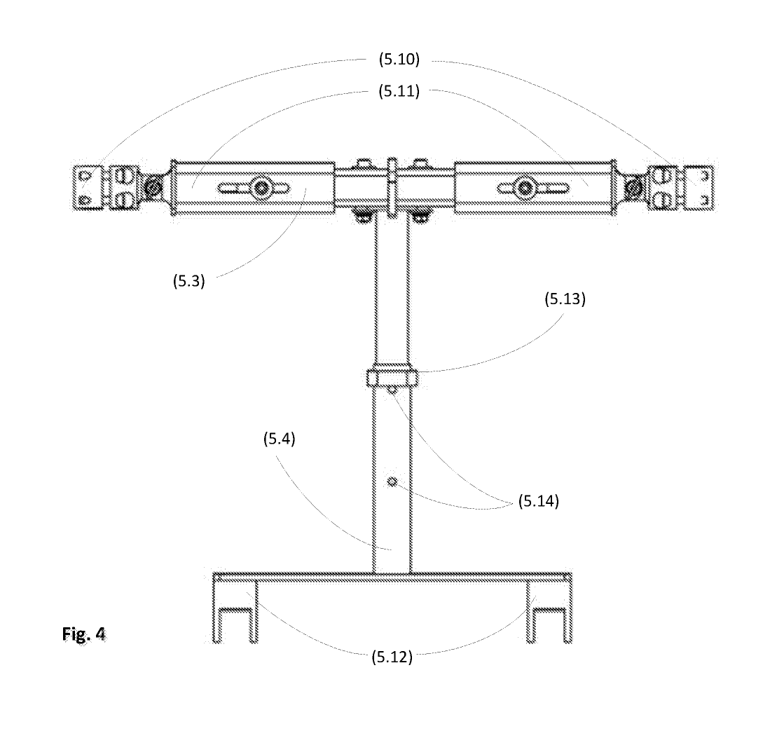

In FIG. 4 there are shown, in further detail, an exemplary (5.3) wheelchair connector of a connection cross bar type, and an exemplary (5.4) rear chassis fork, in accordance with some embodiments of the present invention. In the figure, the following exemplary components and connections are shown: (5.3) a wheelchair connector, connecting the lifting arm to the connection cross bar; (5.10) two connection cross bar to wheelchair frame connectors; (5.11) two horizontal cross bar extension components for elongating and shortening the cross bar to accommodate various wheelchair types/sizes; (5.12) two rear chassis fork rear chassis supporting connectors; and (5.13) a vertical rear chassis fork extension component for elongating and shortening the vertical bar section (e.g. a telescopic bar) of the rear chassis fork to accommodate various wheelchair types/sizes, and wherein the vertical bar comprises (5.14) connection holes/dents at preset points along it.

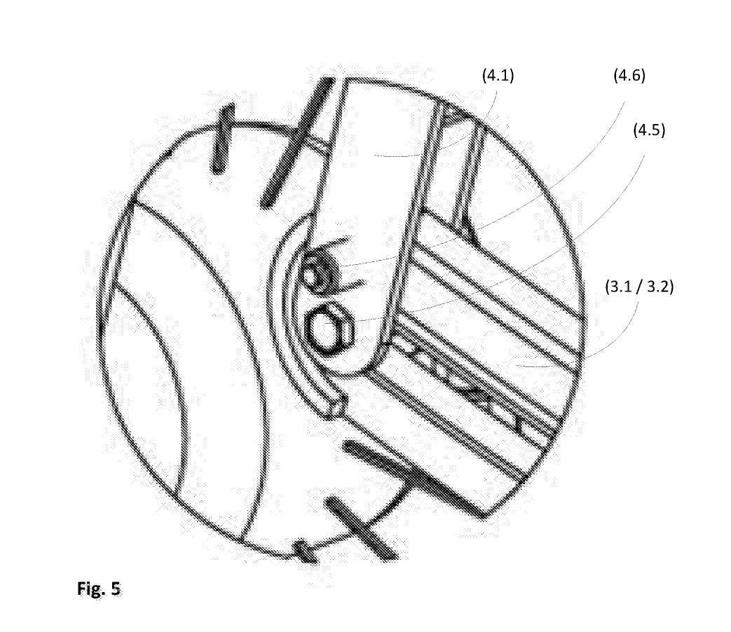

In FIG. 5 there is shown, in further detail, an exemplary rear wheel chassis track to front chassis fork connection, in accordance with some embodiments of the present invention. In the figure, showing a connection of one out of the two tracks, the following exemplary components and connections are shown: (4.5) a front chassis fork track shaft for guiding the trajectory of the tracks, of the traveling rear wheels chassis, as it is being pulled backwards while positioning the rear wheels of the attachment behind the axle of the rear wheels of the wheelchair, and while being pushed back to its initial position; and (4.6) a front chassis fork track locking shaft, for entering/snapping-into a preset hole/dent on the front section of the respective track, while retaining the track at its final pulled back position, and optionally, through another preset hole/dent on the back section of the respective track, for retaining the track at its pushed forward (folded) position.

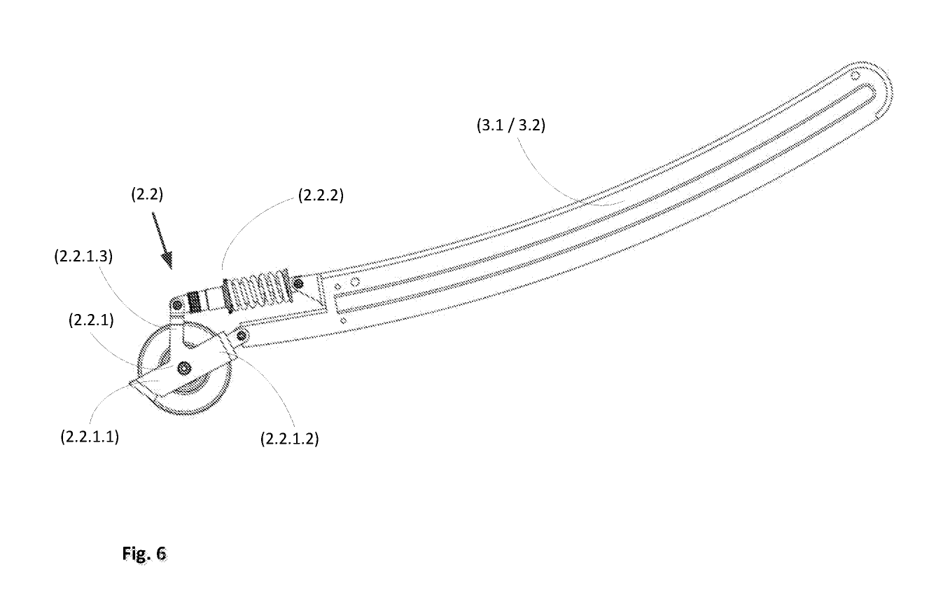

In FIG. 6 there are shown, in further detail, an exemplary rear wheel chassis track connected, utilizing an exemplary shock absorber, to an exemplary rear wheel, in accordance with some embodiments of the present invention.

In the figure there is shown (2.2) a rear wheel suspension and connection element, including: (2.2.1) a wheel connection element encompassing the wheel and including: (2.2.1.1) a first arm for connection to the axle of the wheel, (2.2.1.2) a second arm for connection to the rear section of a respective track of the rear wheels chassis, wherein the connection is an axis (e.g. joint/hinge) type connection allowing the wheel connection element along with its encompassed wheel to move, in an up and down direction, around the connection point of the axis of the track, and/or (2.2.1.3) a third arm, positioned at the top of the wheel connection element, for connection, by an axis (e.g. joint/hinge) type connection, to a first side of a (2.2.2) shock absorber (e.g. coil/spring), wherein the second side of the shock absorber is connected, by an axis (e.g. joint/hinge) type connection, to the top rear section of the respective track of the rear wheels chassis. The shock absorber (e.g. coil/spring) biases the third arm to be pushed backwards, causing the entire wheel connection element to be pushed around the second arm connection point, thus pushing the wheel substantially downward and keeping it in contact with the ground while absorbing shocks, as the wheels pass over non-flat ground sections such as bumps/dimples.

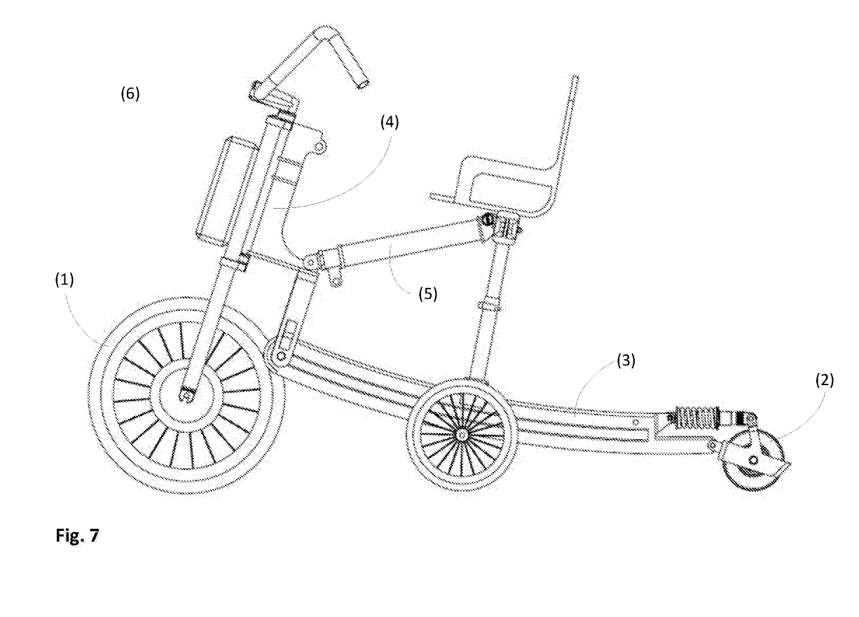

In FIG. 7 there is shown, a perspective view of (6) an exemplary wheelchair including an integrated electric mobility capability, in accordance with some embodiments of the present invention. The exemplary wheelchair shown, includes the elements of a wheelchair and a wheelchair attachment as described hereinbefore, some or all of the following components, however, may be excluded from the integrated electric mobility capability embodiment, or substituted as described. The front caster wheels of the wheelchair, including their connecting elements and corresponding frame section(s), may be excluded as the wheelchair has no standalone (with no attachment) mode; the entire lifting arm and its associated components (lifting arm connector, cross connection bar and actuator) may be substituted with a fixed or axis connected arm or rod, or cancelled altogether; the rear wheels chassis tracks may be replaced with chassis connection rods having no tracks, that may each be connected to the front chassis and/or to the front chassis fork, and optionally to each other, by an axis or by a stiff (e.g. welded, screwed) connection; and the rear chassis fork, according to some embodiments, may be cancelled.

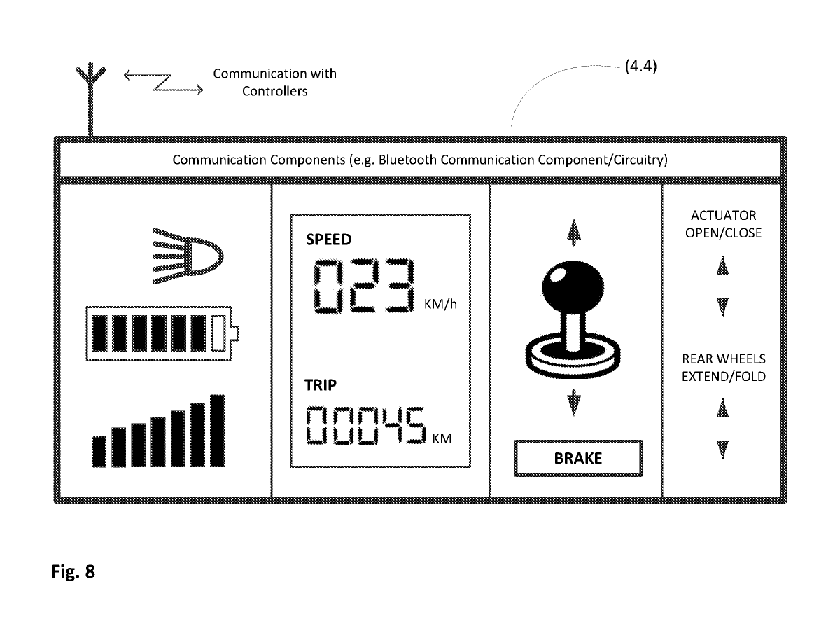

In FIG. 8 there is shown, in further detail, (4.4) an exemplary control and output unit, in accordance with some embodiments of the present invention. The control and output unit shown may be connected to the (4.3) handlebars, while allowing the user (rider), through the shown interface elements, to: (i) relay commands to, or to controllers (e.g. control circuitries, motor controllers) of: the motors, actuator, brakes, lights, and alert sound generation device—the commands include: motor operation commands (e.g. speedup, slowdown), actuator operation commands (e.g. lift wheelchair up, lower wheelchair down), wheelchair attachment braking commands, lights related commands (e.g. light on/off, light blinking signal), and/or alert sound triggering commands; and/or (ii) present to the user (rider), acoustically and/or visually, information received from one or more controllers (e.g. control circuitries, motor controllers)—such information includes: motor operation data (e.g. speed, temperature, load), battery operation data (e.g. remaining power, power drain rate, temperature), and/or wheel operation data (e.g. wheel spinning rate). Further exemplary mechanical control units and/or output units, including: braking handles, an alert bell/horn, and/or a speedometer, may be connected to the (4.3) handlebars and/or to (4.4) the exemplary control and output unit.

According to some embodiments, a Wheelchair Electric Mobility Attachment may comprise: an attachment front wheel; two or more attachment rear wheels; a directing Mechanism (e.g. handlebars); a front wheel fork for functionally connecting the directing mechanism to the front wheel; a front chassis fork; a front chassis for functionally connecting between the front wheel fork and the front chassis fork; and/or a rear wheels chassis functionally connected to the front chassis fork, for positioning the two or more attachment rear wheels, as part of a wheelchair connection scheme, at a position behind (further back from) the axle of the rear wheels of the wheelchair to which the attachment is being connected.

According to some embodiments, the Wheelchair Electric Mobility Attachment may further comprise: a front motor for spinning the attachment front wheel; and two or more rear motors for respectively spinning each of the two or more attachment rear wheels.

According to some embodiments, the Wheelchair Electric Mobility Attachment may further comprise: a control unit for relaying motor operation commands to controllers of: (i) the front motor, and (ii) each of the two or more rear motors, wherein the controllers of at least each of the two or more rear motors are positioned in proximity to their respectively controlled motors, and wherein motor operation commands to the controllers of at least each of the two or more rear motors are relayed wirelessly.

According to some embodiments, the Wheelchair Electric Mobility Attachment may further comprise: a lifting arm for connecting between the front chassis and a front section of the wheelchair to which the attachment is being connected; and an actuator, connected between the front chassis and the lifting arm, for pushing the lifting arm substantially in an upward direction, causing the front section of the wheelchair to rise while disconnecting from the ground front caster wheels thereof.

According to some embodiments, the two or more rear motors of the Wheelchair Electric Mobility Attachment, as part of the wheelchair connection scheme, may be adapted to spin their respective attachment rear wheels a predefined distance in reverse direction, while pulling the rear wheels chassis backwards along with them, to the position wherein the attachment rear wheels are behind (further back from) the axle of the rear wheels of the wheelchair.

According to some embodiments, the Wheelchair Electric Mobility Attachment may further comprise individual rear wheel suspensions for each of the two or more attachment rear wheels.

According to some embodiments, a Wheelchair Electric Mobility Attachment may comprise: an attachment front wheel; two or more attachment rear wheels; a directing Mechanism (e.g. handlebars); a front wheel fork for functionally connecting the directing mechanism to the front wheel; a front chassis fork; a front chassis for functionally connecting between the front wheel fork and the front chassis fork; and a rear wheels chassis functionally connected to the front chassis fork, for positioning the two or more attachment rear wheels, as part of a wheelchair connection scheme, at a position forming a substantially convex pentagon shaped form, when viewed from the top, wherein the two or more attachment rear wheels constitute a first vertex and a second vertex at each of the two edges of the base of the pentagon, the front wheel of the attachment constitutes the opposite vertex, and each of the rear wheels of the wheelchair constitutes one of the other two (side) vertexes of the convex pentagon shape.

According to some embodiments, an Electric Mobility Wheelchair may comprise: a front wheel; two or more rear wheels; two side wheels; a directing Mechanism (e.g. handlebars); a front wheel fork for functionally connecting the directing mechanism to the front wheel; a front chassis fork; a front chassis for functionally connecting between the front wheel fork and the front chassis fork; and a rear wheels chassis functionally connected to the front chassis fork, for positioning the two or more rear wheels, at a position: (i) behind (further back from) the axle of the side wheels, and (ii) at a position forming a substantially convex pentagon shaped form, when viewed from the top, wherein the two or more attachment rear wheels constitute a first vertex and a second vertex at each of the two edges of the base of the pentagon, the front wheel of the attachment constitutes the opposite vertex, and each of the rear wheels of the wheelchair constitutes one of the other two (side) vertexes of the convex pentagon shape.

According to some embodiments, the Electric Mobility Wheelchair may further comprise a side swiveling chair.

The subject matter described above is provided by way of illustration only and should not be constructed as limiting. While certain features of the invention have been illustrated and described herein, many modifications, substitutions, changes, and equivalents will now occur to those skilled in the art. It is, therefore, to be understood that the appended claims are intended to cover all such modifications and changes as fall within the true spirit of the invention.

1. A Wheelchair Electric Mobility Attachment comprising:
an attachment front wheel;
two or more attachment rear wheels;
a directing Mechanism (e.g. handlebars);
a front wheel fork for functionally connecting said directing mechanism to said front wheel;
a front chassis fork;
a front chassis for functionally connecting between said front wheel fork and said front chassis fork; and
a rear wheels chassis functionally connected to said front chassis fork, for positioning said two or more attachment rear wheels, as part of a wheelchair connection scheme, at a position behind (further back from) the axle of the rear wheels of the wheelchair to which said attachment is being connected.

2. The Wheelchair Electric Mobility Attachment according to claim 1, further comprising:
a front motor for spinning said attachment front wheel; and
two or more rear motors for respectively spinning each of said two or more attachment rear wheels.

3. The Wheelchair Electric Mobility Attachment according to claim 2, further comprising a control unit for relaying motor operation commands to controllers of: (i) said front motor, and (ii) each of said two or more rear motors, wherein the controllers of at least each of said two or more rear motors are positioned in proximity to their respectively controlled motors, and wherein motor operation commands to the controllers of at least each of said two or more rear motors are relayed wirelessly.

4. The Wheelchair Electric Mobility Attachment according to claim 1, further comprising:
a lifting arm for connecting between said front chassis and a front section of the wheelchair to which said attachment is being connected; and
an actuator, connected between said front chassis and said lifting arm, for pushing said lifting arm substantially in an upward direction, causing the front section of the wheelchair to rise while disconnecting from the ground front caster wheels thereof.

5. The Wheelchair Electric Mobility Attachment according to claim 2, wherein as part of the wheelchair connection scheme, said two or more rear motors are adapted to spin their respective said attachment rear wheels a predefined distance in reverse direction, while pulling said rear wheels chassis backwards along with them, to the position wherein said attachment rear wheels are behind (further back from) the axle of the rear wheels of the wheelchair.

6. The Wheelchair Electric Mobility Attachment according to claim 2, further comprising individual rear wheel suspensions for each of said two or more attachment rear wheels.

7. A Wheelchair Electric Mobility Attachment comprising:
an attachment front wheel;
two or more attachment rear wheels;
a directing Mechanism (e.g. handlebars);
a front wheel fork for functionally connecting said directing mechanism to said front wheel;
a front chassis fork;
a front chassis for functionally connecting between said front wheel fork and said front chassis fork; and
a rear wheels chassis functionally connected to said front chassis fork, for positioning said two or more attachment rear wheels, as part of a wheelchair connection scheme, at a position forming a substantially convex pentagon shaped form, when viewed from the top, wherein said two or more attachment rear wheels constitute a first vertex and a second vertex at each of the two edges of the base of the pentagon, the front wheel of the attachment constitutes the opposite vertex, and each of the rear wheels of the wheelchair constitutes one of the other two (side) vertexes of the convex pentagon shape.

8. An Electric Mobility Wheelchair comprising:
a front wheel;
two or more rear wheels;
two side wheels;
a directing Mechanism (e.g. handlebars);
a front wheel fork for functionally connecting said directing mechanism to said front wheel;
a front chassis fork;
a front chassis for functionally connecting between said front wheel fork and said front chassis fork; and
a rear wheels chassis functionally connected to said front chassis fork, for positioning said two or more rear wheels, at a position: (i) behind (further back from) the axle of said side wheels, and (ii) at a position forming a substantially convex pentagon shaped form, when viewed from the top, wherein said two or more attachment rear wheels constitute a first vertex and a second vertex at each of the two edges of the base of the pentagon, the front wheel of the attachment constitutes the opposite vertex, and each of the rear wheels of the wheelchair constitutes one of the other two (side) vertexes of the convex pentagon shape.

9. The Electric Mobility Wheelchair according to claim 8, further comprising:
a side swiveling chair.
